(19) United States
(12) Patent Application Publication
(10) Pub. No.: US 2026/0246166 A1
(43) Pub. Date: Aug. 20, 2026

(54) TERMINAL AND CONNECTOR

(71) Applicant: SUMITOMO WIRING SYSTEMS, LTD., Mie (JP)

(72) Inventor: Daichi MATSUBARA, Mie (JP)

(21) Appl. No.: 19/537,110

(22) Filed: Feb. 11, 2026

(30) Foreign Application Priority Data
Feb. 18, 2025 (JP) 2025-024202

(51) Int. Cl. H01R 4/48; H01R 9/18; H01R 9/24

(52) U.S. Cl. CPC H01R 4/4811; H01R 9/18; H01R 9/2416

(57) ABSTRACT

A terminal includes a terminal body that has a busbar fastening portion to be bolted to a busbar, and a spring member that has a spring piece configured to come into contact with a partner terminal, and is joined to the terminal body. The terminal body includes a first attachment piece that extends from a first end that is an end of the busbar fastening portion in a first direction (upward side) orthogonal to a bolt axis line, and a second attachment piece that extends from a second end that is an end of the busbar fastening portion in a second direction (downward side) opposite to the first direction so as to oppose the first attachment piece. The spring member is attached between the first attachment piece and the second attachment piece and is joined to the first attachment piece and the second attachment piece.

### CROSS-REFERENCE TO RELATED APPLICATIONS

This application is based on and claims priority from Japanese Patent Application No. 2025-024202, filed on February 18, 2025, with the Japan Patent Office, the disclosure of which is incorporated herein in its entirety by reference.

### TECHNICAL FIELD

The present disclosure relates to a terminal and a connector.

### BACKGROUND

For example, a terminal described in JP 2024-021632A has a terminal body (body portion in JP 2024-021632A) in which a box-shaped conductor portion storing a contact-forming fitting and a flat connection portion conductively connected to another member are integrated. The terminal body is formed by punching out a predetermined shape from a single metal plate. The contact-forming fitting includes a spring piece that extends inside the box-shaped conductor portion. The terminal body and the contact-forming fitting are each individually press-formed and then fixed to each other by welding or the like. The spring piece of the contact-forming fitting elastically comes into contact with a partner terminal inserted into the box-shaped conductor portion, thereby establishing an electrical connection between the terminal and the partner terminal.

### SUMMARY

In the above-described terminal, an issue lies in how to suppress heat generation in the terminal body when current is applied.

An object of the present disclosure is to provide a terminal and a connector that can suppress heat generation in the terminal body.

The terminal of the present disclosure includes a terminal body that has a busbar fastening portion configured to be bolted to a busbar, and a spring member that has a spring piece configured to come into contact with a partner terminal, and is joined to the terminal body, wherein the terminal body includes: a first attachment piece that extends from a first end that is an end of the busbar fastening portion in a first direction orthogonal to a bolt axis line; and a second attachment piece that extends from a second end that is an end of the busbar fastening portion in a second direction opposite to the first direction so as to oppose the first attachment piece, and the spring member is attached between the first attachment piece and the second attachment piece and is joined to the first attachment piece and the second attachment piece.

According to the terminal and connector of the present disclosure, it is possible to suppress heat generation in the terminal body.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector according to an embodiment.

FIG. 2 is an exploded perspective view of the connector according to the embodiment, as seen from the rear side.

FIG. 3 is a cross-sectional view taken along line 3-3 in FIG. 2.

FIG. 4 is an exploded perspective view of a terminal according to the embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Disclosure

First, embodiments of the present disclosure will be listed and described.

[1] A terminal of the present disclosure includes a terminal body that has a busbar fastening portion configured to be bolted to a busbar, and a spring member that has a spring piece configured to come into contact with a partner terminal, and is joined to the terminal body, wherein the terminal body includes: a first attachment piece that extends from a first end that is an end of the busbar fastening portion in a first direction orthogonal to a bolt axis line; and a second attachment piece that extends from a second end that is an end of the busbar fastening portion in a second direction opposite to the first direction so as to oppose the first attachment piece, and the spring member is attached between the first attachment piece and the second attachment piece and is joined to the first attachment piece and the second attachment piece.

With this configuration, the current from the partner terminal in contact with the spring piece of the spring member flows from the spring member, splitting into the first attachment piece and the second attachment piece. The current flowing through the first attachment piece and the current flowing through the second attachment piece then merge at the busbar fastening portion and flow to the busbar. That is, the current flowing through the first attachment piece and the current flowing through the second attachment piece do not merge together until they reach the busbar fastening portion to which the busbar is bolted. This prevents a local increase in heat generation due to the current flowing through the first attachment piece and the current flowing through the second attachment piece merging before reaching the busbar fastening portion, and as a result, it is possible to suppress heat generation in the terminal body.

[2] In [1] above, the first attachment piece and the second attachment piece of the terminal body may be formed integrally with the busbar fastening portion by bending.

With this configuration, it is easy to form the first attachment piece and the second attachment piece. It is also possible to simplify the unfolded shape of the terminal body including the busbar fastening portion, the first attachment piece, and the second attachment piece. Therefore, in the case of forming the terminal body by punching from a plate-shaped material, it is possible to reduce the loss of the plate-shaped material that is discarded during punching.

[3] In [2] above, the first attachment piece and the second attachment piece may have a first arrangement portion and a second arrangement portion, respectively, the spring member may be arranged between the first arrangement portion and the second arrangement portion, the first attachment piece may have a first bent portion formed by bending a portion between the first end and the first arrangement portion, and the second attachment piece may have a second bent portion formed by bending a portion between the second end and the second arrangement portion.

With this configuration, the first bent portion and the second bent portion can improve the rigidity of the first attachment piece and the second attachment piece against torque generated at the time of bolt fastening at the busbar fastening portion. This suppresses deformation of the first attachment piece and the second attachment piece at the time of bolt fastening.

[4] In [3] above, the first attachment piece may have a first inclined portion that is inclined in the first direction toward the first end from the first bent portion, and the second attachment piece may have a second inclined portion that is inclined in the second direction toward the second end from the second bent portion.

With this configuration, the first inclined portion of the first attachment piece and the second inclined portion of the second attachment piece are inclined so as to widen outward as they approach the busbar fastening portion. This ensures space between the first inclined portion and the second inclined portion, and as a result, it is possible to easily ensure space for arranging a nut at the busbar fastening portion, for example.

[5] A connector of the present disclosure includes the terminal according to any one of above [1] to [4], and a housing having a cavity for storing the terminal.

With this configuration, the current from the partner terminal in contact with the spring piece of the spring member flows from the spring member, splitting into the first attachment piece and the second attachment piece. The current flowing through the first attachment piece and the current flowing through the second attachment piece then merge at the busbar fastening portion and flow to the busbar. That is, the current flowing through the first attachment piece and the current flowing through the second attachment piece do not merge together until they reach the busbar fastening portion to which the busbar is bolted. This prevents a local increase in heat generation due to the current flowing through the first attachment piece and the current flowing through the second attachment piece merging before reaching the busbar fastening portion, and as a result, it is possible to suppress heat generation in the terminal body.

### Detailed Description of Embodiments of Disclosure

Specific examples of a terminal and a connector of the present disclosure will be described below with reference to the drawings. In the diagrams, part of the configuration may be shown in an exaggerated or simplified manner for convenience of description. Also, the dimensional ratios of various portions may differ between diagrams. The diagrams illustrate X, Y, and Z axes that are orthogonal to each other. The front-rear direction of the connector is along the X axis. The diagrams illustrate frontward X1, which is along the X axis, and rearward X2, which is the opposite direction thereto. The width direction of the connector is along the Y axis. The height direction of the connector is along the Z axis. The diagrams illustrate upward Z1, which is one side in the height direction along the Z axis, and downward Z2, which is the opposite direction thereto. Note that the connector is not necessarily used with upward Z1 pointing skyward.

Herein, "perpendicular" and "orthogonal" are not only strictly perpendicular or orthogonal and may also include approximately perpendicular or orthogonal within a range that achieves the operation and effect of the present embodiment. "Tubular" as used in the description herein includes not only a shape with a peripheral wall formed continuously around the entire circumferential direction, but also a shape obtained by combining a plurality of parts to form a tubular shape, and a shape that is partially cut out in the peripheral direction, such as a C-shape. A "tubular" outer peripheral shape includes, but is not limited to, a circular shape, an elliptical shape, and a polygonal shape with pointed or rounded corners. "Tubular" is a shape having a through hole in plan view, and includes shapes whose outer peripheral shape is the same as the inner peripheral shape of the through hole, and shapes whose outer peripheral shape differs from the inner peripheral shape of the through hole. "Tubular" includes a shape having a predetermined length extending in an axial direction in which a central axis that passes through the center of the through hole extends, and may be any length. Also, "opposing" herein refers to two surfaces or members being positioned in front of each other, and includes not only the case where the two portions are perfectly in front of each other, but also the case where the two portions are partially in front of each other. Also, "opposing" herein includes both the case where another member different from the two portions is interposed between the two portions, and the case where another member is not interposed between the two portions. Also, terms such as "first", "second", "third", and "fourth" herein are simply used to distinguish between objects, and do not rank objects. The present invention is not limited to these illustrative examples and is indicated by the claims, and all changes that come within the meaning and range of equivalency of the claims are intended to be embraced therein.

### Configuration of Connector 10

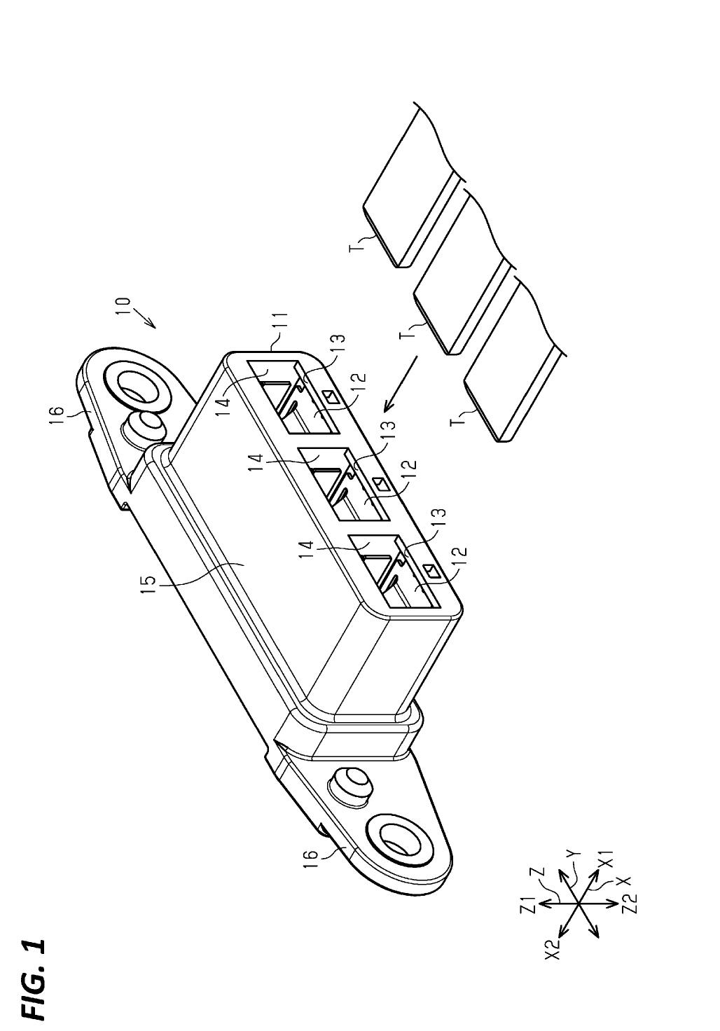

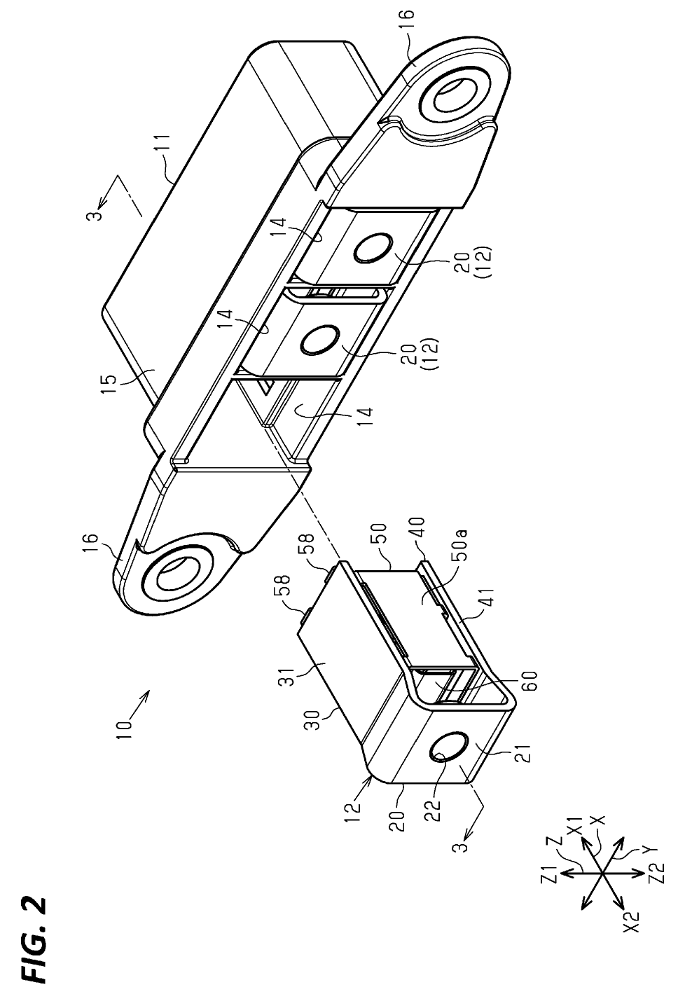

As shown in FIGS. 1 and 2, a connector 10 includes a housing 11 and a terminal 12 stored in the housing 11. The connector 10 is a high-voltage connector capable of handling high voltages and large currents, for example. The connector 10 is fitted onto to a partner connector (not shown). The terminal 12 of the connector 10 is configured to be electrically connected to a partner terminal T of the partner connector.

The connector 10 includes, for example, a plurality of terminals 12 (three in the present embodiment). The plurality of terminals 12 are arranged side by side in the width direction (Y-axis direction). The plurality of terminals 12 are electrically connected to individual partner terminals T. As shown in FIG. 1, an end face on the frontward X1 side of the housing 11 is provided with openings 13 through which the partner terminals T are inserted toward the rearward X2 side. Three openings 13 are provided in correspondence with the number of terminals 12. The partner terminals T are inserted into the terminals 12 inside the housing 11.

### Configuration of Housing 11

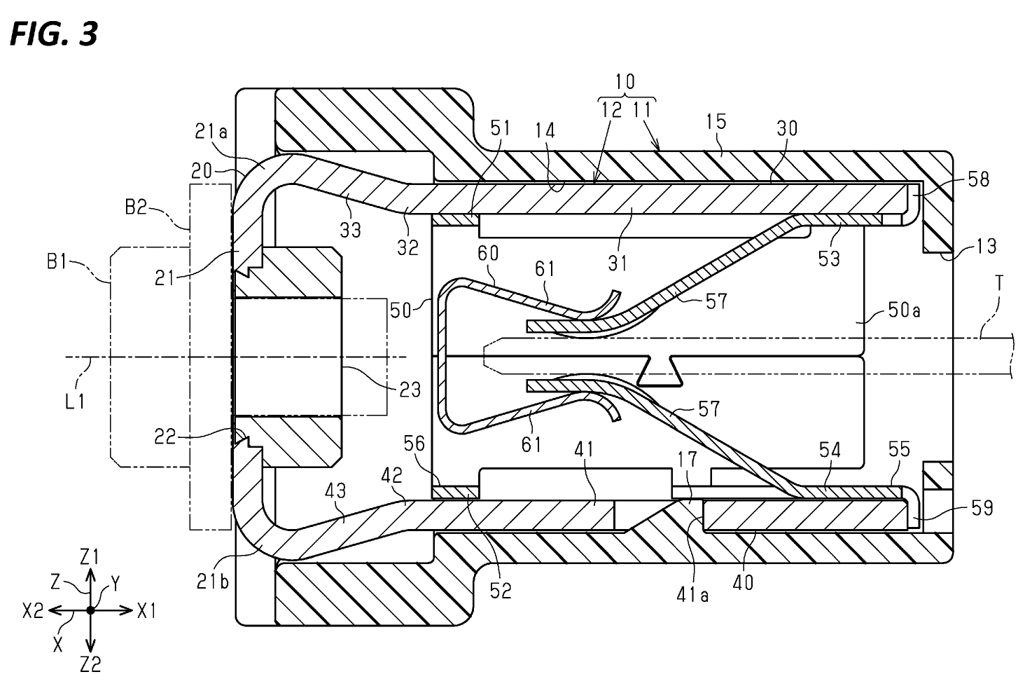

As shown in FIG. 2, the housing 11 includes a body portion 15 having cavities 14 therein, and a fixing portion 16 integral with the body portion 15. The housing 11 is made of a synthetic resin, for example. FIG. 2 shows a state in which one of the plurality of terminals 12 is removed from a cavity 14. FIG. 3 is a cross-sectional view taken along line 3-3 in FIG. 2, showing a state in which the terminal 12 is stored in the cavity 14.

As shown in FIGS. 2 and 3, the body portion 15 has three cavities 14 in correspondence with the number of terminals 12. The plurality of cavities 14 are arranged side by side in the width direction (Y-axis direction). Each terminal 12 is stored in the corresponding cavity 14. Each cavity 14 is in communication with the corresponding opening 13 described above. The partner terminals T are inserted into the cavities 14 through the openings 13. Each terminal 12 is attached from the end on the rearward X2 side toward the frontward X1 side of the cavity 14. As shown in FIG. 3, each cavity 14 includes a locking portion 17 that protrudes into the cavity 14. The locking portion 17 locks onto the terminal 12 to prevent the terminal 12 from slipping out of the cavity 14 toward the rearward X2 side.

As shown FIGS. 1 and 2, the housing 11 includes a pair of fixing portions 16, for example. The pair of fixing portions 16 extend from the end on the rearward X2 side of the body portion 15 to both sides in the width direction (Y-axis direction), for example. Each fixing portion 16 is fixed to, for example, a device case serving as a fixing target to which the connector 10 is fixed by bolting, for example.

### Configuration of Terminal 12

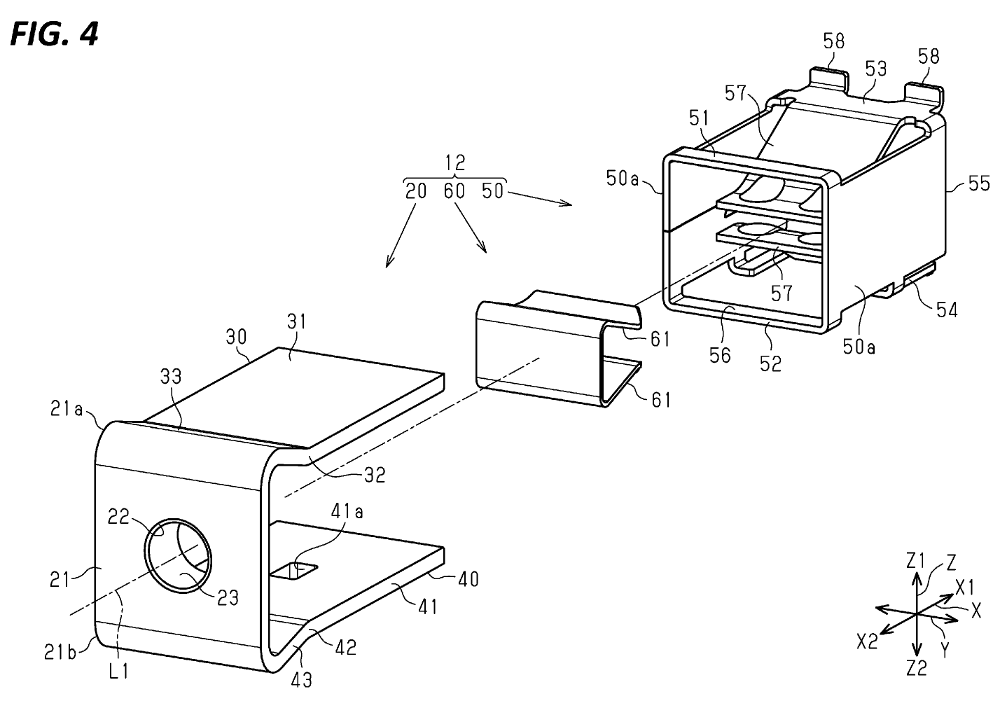

As shown in FIGS. 3 and 4, each terminal 12 of the present embodiment includes a terminal body 20, a spring member 50, and a clip 60, for example. The terminal body 20, the spring member 50, and the clip 60 are separate components. The terminal body 20 and the spring member 50 are each made of a conductor such as metal. The terminal body 20 is integrally formed by pressing a plate-shaped material of uniform thickness. The spring member 50 is integrally formed by pressing a plate-shaped material of uniform thickness, which is thinner than the terminal body 20. The plate thickness of the spring member 50 is set to half or less the plate thickness of the terminal body 20, for example.

### Configuration of Terminal Body 20

The terminal body 20 includes a busbar fastening portion 21, a first attachment piece 30, and a second attachment piece 40. Since the terminal body 20 is formed by pressing a plate-shaped material as described above, the busbar fastening portion 21, the first attachment piece 30, and the second attachment piece 40 each have a plate shape.

### Configuration of Busbar Fastening portion 21

The busbar fastening portion 21 is formed in a plate shape perpendicular to the insertion direction (rearward X2 side in the present embodiment) of the partner terminal T into the terminal 12. That is, the plate thickness direction of the busbar fastening portion 21 coincides with the front-rear direction (X-axis direction).

As shown in FIG. 3, the busbar fastening portion 21 has a through hole 22 that penetrates the busbar fastening portion 21 in the front-rear direction. A nut 23 into which a bolt B1 can be screwed is fixed by welding or press-fitting to a surface of the busbar fastening portion 21 on the frontward X1 side at a position corresponding to the through hole 22, for example. The busbar fastening portion 21 is fastened to a busbar B2 by the bolt B1 and the nut 23, for example. The busbar B2 is a conductive member provided inside the device case to which the connector 10 is fixed, for example. A bolt axis line L1 of the busbar fastening portion 21 extends along the X-axis.

### Configuration of First Attachment Piece 30 and Second Attachment Piece 40

As shown in FIGS. 3 and 4, the first attachment piece 30 extends to the frontward X1 side from a first end 21a, which is the end of the busbar fastening portion 21 in a first direction (here, the upward Z1 side) orthogonal to the bolt axis line L1. The second attachment piece 40 extends to the frontward X1 side from a second end 21b, which is the end of the busbar fastening portion 21 in a second direction (here, the downward Z2 side) opposite to the first direction. The first attachment piece 30 and the second attachment piece 40 are formed integrally with the busbar fastening portion 21 by bending. The first attachment piece 30 and the second attachment piece 40 are formed so as to oppose each other in the Z-axis direction. The first attachment piece 30 and the second attachment piece 40 are approximately symmetrical.

The first attachment piece 30 and the second attachment piece 40 have a first arrangement portion 31 and a second arrangement portion 41, respectively. The spring member 50 is arranged between the first arrangement portion 31 and the second arrangement portion 41. The first arrangement portion 31 and the second arrangement portion 41 are formed in the shape of plates perpendicular to the Z-axis direction, for example. The first arrangement portion 31 and the second arrangement portion 41 oppose each other in the Z-axis direction and are parallel to each other, for example. Of the first arrangement portion 31 and the second arrangement portion 41, for example, the second arrangement portion 41 has a locking hole 41a in which the locking portion 17 of the housing 11 is locked. The locking portion 17 is locked in the locking hole 41a to prevent the terminal 12 from slipping out of the cavity 14 to the rearward X2 side.

The first attachment piece 30 includes a first bent portion 32 formed by bending a portion between the first end 21a of the busbar fastening portion 21 and the first arrangement portion 31. The first attachment piece 30 also includes a first inclined portion 33 that is inclined to the upward Z1 side toward the first end 21a from the first bent portion 32.

The second attachment piece 40 includes a second bent portion 42 formed by bending a portion between the second end 21b of the busbar fastening portion 21 and the second arrangement portion 41. The second attachment piece 40 also includes a second inclined portion 43 that is inclined to the downward Z2 side toward the second end 21b from the second bent portion 42. The first inclined portion 33 and the second inclined portion 43 oppose each other in the Z-axis direction and incline so as to widen outward in the Z-axis direction as they approach the busbar fastening portion 21. The nut 23 fixed to the back surface (the surface on the frontward X1 side) of the busbar fastening portion 21 is arranged between the first inclined portion 33 and the second inclined portion 43.

The terminal body 20 including the busbar fastening portion 21, the first attachment piece 30, and the second attachment piece 40 as described above is formed into an approximate U-shape by punching a straight band-shaped material from a metal plate and bending the band-shaped material such that both longitudinal ends are oriented in the same direction, for example. Bending the first bent portion 32 and the second bent portion 42 of the first attachment piece 30 and the second attachment piece 40, respectively, improves the rigidity of the busbar fastening portion 21 against torque generated at the time of bolt fastening, for example.

### Configuration of Spring Member 50

As shown in FIG. 4, the spring member 50 of each terminal 12 includes a pair of side wall portions 50a opposing each other in the Y-axis direction, and a plurality of coupling portions 51, 52, 53, and 54 coupling the pair of side wall portions 50a. In the spring member 50 of the present embodiment, the number of the plurality of coupling portions 51, 52, 53, and 54 is four in total, two on the front and two on the back, for example, and these coupling portions will be referred to as a first coupling portion 51, a second coupling portion 52, a third coupling portion 53, and a fourth coupling portion 54. Each side wall portion 50a of the spring member 50 has a flat plate shape perpendicular to the Y-axis direction, for example. Each side wall portion 50a also has a substantially rectangular shape in a view in the Y-axis direction, for example.

The first coupling portion 51 and the second coupling portion 52 of the spring member 50 are provided at the rear end (end on the rearward X2 side) of the spring member 50. The first coupling portion 51 couples the upper ends of the side wall portions 50a at the rear end of the spring member 50. The second coupling portion 52 couples the lower ends of the side wall portions 50a at the rear end of the spring member 50. The third coupling portion 53 and the fourth coupling portion 54 are provided nearer to the frontward X1 side than the first coupling portion 51 and the second coupling portion 52. The third coupling portion 53 couples the upper ends of the side wall portions 50a. The fourth coupling portion 54 couples the lower ends of the side wall portions 50a.

As shown in FIGS. 3 and 4, the spring member 50 has a partner terminal insertion port 55 at the front end (the end on the frontward X1 side) of the spring member 50. The partner terminal insertion port 55 is constituted of the pair of side wall portions 50a and the front ends of the third coupling portion 53 and fourth coupling portion 54. The partner terminal T is inserted into the partner terminal insertion port 55 toward the rearward X2 side. The spring member 50 has a clip insertion port 56 at the rear end (the end on the rearward X2 side) of the spring member 50. The clip insertion port 56 is constituted by the pair of side wall portions 50a and the rear ends of the first coupling portion 51 and second coupling portion 52.

### Configuration of Spring Piece 57

As shown in FIG. 3, the spring member 50 has two spring pieces 57, for example. The two spring pieces 57 extend from the third coupling portion 53 and the fourth coupling portion 54 to the rearward X2 side while inclining toward each other. The two spring pieces 57 are located between the pair of side wall portions 50a and oppose each other in the Z-axis direction. The partner terminal T is inserted between the two spring pieces 57 through the partner terminal insertion port 55 toward the rearward X2 side.

The spring member 50 includes first stoppers 58 extending from the third coupling portion 53. The first stoppers 58 abut against the front end (the end on the frontward X1 side) of the first attachment piece 30 toward the rearward X2 side. The spring member 50 also includes second stoppers 59 extending from the fourth coupling portion 54. The second stoppers 59 abut against the front end (the end on the frontward X1 side) of the second attachment piece 40 toward the rearward X2 side.

The spring member 50 is joined to the first attachment piece 30 and the second attachment piece 40 of the terminal body 20 by laser welding, arc welding, gas welding, spot welding (resistance welding), ultrasonic welding, or the like, for example. Specifically, the third coupling portion 53 of the spring member 50 is joined to a portion of the first attachment piece 30 near the front end of the first arrangement portion 31. The fourth coupling portion 54 of the spring member 50 is joined to a portion of the second attachment piece 40 near the front end of the second arrangement portion 41. This electrically connects the spring member 50 to the first attachment piece 30 and the second attachment piece 40. Current flows from the spring member 50 to the first attachment piece 30 and the second attachment piece 40 mainly via the above-described joint portions. The methods for joining the terminal body 20 and the spring member 50 are not limited to the various welding methods described above, and dowel caulking or the like can also be used.

### Configuration of Clip 60

As shown in FIG. 3, the clip 60 is inserted into the clip insertion port 56 toward the frontward X1 side and attached to the leading ends (here, ends on the rearward X2 side) of the pair of spring pieces 57. The clip 60 applies a pressing force to the pair of spring pieces 57 in a direction in which they approach each other. The clip 60 is formed by pressing a metal plate, for example. The clip 60 is separate from the terminal body 20 and the spring member 50. Among the components of the terminal 12, the clip 60 is not a component that requires electrical connection. Therefore, the clip 60 can be made of a material that is less conductive of electricity, or an insulator. The material for the clip 60 is stainless steel, for example.

The clip 60 has a pair of arms 61 that sandwich the pair of spring pieces 57. The pair of arms 61 are inclined in a direction of approaching each other toward the frontward X1 side. The pair of arms 61 exert a spring force in the direction of approaching each other. The pair of spring pieces 57 that oppose each other in the Z-axis direction are biased in the direction of approaching each other by the elasticity of the clip 60. This ensures that even if a positional shift in the Z-axis direction occurs between the terminal 12 and the partner terminal T due to manufacturing tolerances or the like, the force (contact pressure) with which the pair of spring pieces 57 sandwich the partner terminal T in the Z-axis direction remains unchanged as much as possible.

### Operation of Present Embodiment

The operation of the present embodiment will be described below.

The current from the partner terminal T in contact with each spring piece 57 of the spring member 50 flows from the spring member 50, splitting into the first attachment piece 30 and the second attachment piece 40. The current flowing through the first attachment piece 30 and the current flowing through the second attachment piece 40 merge at the busbar fastening portion 21 and then flow to the busbar B2. That is, the terminal 12 of the present embodiment is configured such that the current flowing through the first attachment piece 30 and the current flowing through the second attachment piece 40 do not merge together until they reach the busbar fastening portion 21 that is bolted to the busbar B2. This prevents a local increase in heat generation caused by the current flowing through the first attachment piece 30 and the current flowing through the second attachment piece 40 merging together before reaching the busbar fastening portion 21. As a result, heat generation in the terminal body 20 can be suppressed.

### Advantageous Effects of Present Embodiment

Advantageous effects of the present embodiment will be described below.
(1) The terminal body 20 of the terminal 12 includes the first attachment piece 30 extending from the first end 21a of the busbar fastening portion 21, and the second attachment piece 40 extending from the second end 21b of the busbar fastening portion 21 so as to oppose the first attachment piece 30. The spring member 50 is attached between the first attachment piece 30 and the second attachment piece 40, and is joined to the first attachment piece 30 and the second attachment piece 40. With this configuration, the current flowing through the first attachment piece 30 and the current flowing through the second attachment piece 40 do not merge before reaching the busbar fastening portion 21, preventing a local increase in heat generation. As a result, heat generation in the terminal body 20 can be suppressed.
(2) The first attachment piece 30 and the second attachment piece 40 of the terminal body 20 are formed integrally with the busbar fastening portion 21 by bending. With this configuration, it is possible to easily form the first attachment piece 30 and the second attachment piece 40. It is also possible to simplify the unfolded shape of the terminal body 20 including the busbar fastening portion 21, the first attachment piece 30, and the second attachment piece 40 (for example, into a linear band shape). Therefore, in the case of forming the terminal body 20 by punching from a plate-shaped material, it is possible to minimize the loss of the plate-shaped material that would be discarded after punching.
(3) The first attachment piece 30 and the second attachment piece 40 have the first arrangement portion 31 and the second arrangement portion 41, respectively. The spring member 50 is arranged between the first arrangement portion 31 and the second arrangement portion 41. The first attachment piece 30 includes the first bent portion 32 formed by bending a portion between the first end 21a and the first arrangement portion 31. The second attachment piece 40 has the second bent portion 42 formed by bending a portion between the second end 21b and the second arrangement portion 41. With this configuration, the first bent portion 32 and the second bent portion 42 can improve the rigidity of the first attachment piece 30 and the second attachment piece 40 against torque generated at the time of bolt fastening at the busbar fastening portion 21. This makes it possible to suppress deformation of the first attachment piece 30 and the second attachment piece 40 at the time of bolt fastening.
(4) The first attachment piece 30 has the first inclined portion 33 that is inclined in the first direction (here, the upward Z1 side) toward the first end 21a from the first bent portion 32. The second attachment piece 40 has the second inclined portion 43 that is inclined in the second direction (here, the downward Z2 side) toward the second end 21b from the second bent portion 42. With this configuration, the first inclined portion 33 of the first attachment piece 30 and the second inclined portion 43 of the second attachment piece 40 incline to widen outward as they approach the busbar fastening portion 21. This ensures space between the first inclined portion 33 and the second inclined portion 43, and as a result, it is possible to easily ensure space for arranging the nut 23 at the busbar fastening portion 21, for example.

### Other Embodiments

The above embodiment can be modified as described below. The above embodiment and the following modifications can be combined with each other to the extent that no technical contradiction occurs.

In the terminal body 20, the first inclined portion 33 of the first attachment piece 30 may be inclined to the downward Z2 side toward the first end 21a of the busbar fastening portion 21 from the first bent portion 32. The second inclined portion 43 of the second attachment piece 40 may be inclined to the upward Z1 side toward the second end 21b of the busbar fastening portion 21 from the second bent portion 42. That is, the first inclined portion 33 and the second inclined portion 43 may be inclined so as to narrow inward as they approach the busbar fastening portion 21.

In the first attachment piece 30 and the second attachment piece 40 of the terminal body 20, the first bent portion 32 and the second bent portion 42 may each be formed in a crank shape that is bent at approximate right angle, and the first inclined portion 33 and the second inclined portion 43 may be omitted.

In the terminal body 20, the first bent portion 32 and the second bent portion 42 may be omitted respectively from the first attachment piece 30 and the second attachment piece 40. In this case, the first attachment piece 30 and the second attachment piece 40 may extend linearly from the first end 21a and the second end 21b of the busbar fastening portion 21, respectively, toward the frontward X1 side.

In the terminal body 20, the first attachment piece 30 and the second attachment piece 40 may extend from both ends (first end and second end) of the busbar fastening portion 21 in the width direction (Y-axis direction) orthogonal to the bolt axis line L1.

In the terminal body 20 of the above embodiment, the busbar fastening portion 21 is configured such that the bolt axis line L1 is aligned with the X-axis. However, the present disclosure is not limited to this configuration, and the bolt axis line L1 may be configured so as to be inclined with respect to the X-axis.

The molding form of the terminal body 20 is not limited to that in the above embodiment, and can be changed as appropriate depending on the configuration of the terminal 12.

The configuration of the spring member 50, such as its shape, is not limited to that in the above embodiment, and can be changed as appropriate depending on the configuration of the terminal 12. For example, in the spring member 50 of the above embodiment, the number and shape of the coupling portions 51, 52, 53, and 54 may be changed. The shape of the pair of side wall portions 50a may also be changed. The number and shape of the spring pieces 57 may also be changed.

In the terminal 12 of the above embodiment, the clip 60 may be omitted.

The number of terminals 12 included in the connector 10 is not limited to that in the above embodiment, and may be one, two, or four or more.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A terminal comprising:
a terminal body that has a busbar fastening portion configured to be bolted to a busbar; and
a spring member that has a spring piece configured to come into contact with a partner terminal, and is joined to the terminal body,
wherein the terminal body includes:
a first attachment piece that extends from a first end that is an end of the busbar fastening portion in a first direction orthogonal to a bolt axis line; and
a second attachment piece that extends from a second end that is an end of the busbar fastening portion in a second direction opposite to the first direction so as to oppose the first attachment piece, and
the spring member is attached between the first attachment piece and the second attachment piece and is joined to the first attachment piece and the second attachment piece.

2. The terminal according to claim 1, wherein the first attachment piece and the second attachment piece of the terminal body are formed integrally with the busbar fastening portion by bending.

3. The terminal according to claim 2,
wherein the first attachment piece and the second attachment piece have a first arrangement portion and a second arrangement portion, respectively,
the spring member is arranged between the first arrangement portion and the second arrangement portion,
the first attachment piece has a first bent portion formed by bending a portion between the first end and the first arrangement portion, and
the second attachment piece has a second bent portion formed by bending a portion between the second end and the second arrangement portion.

4. The terminal according to claim 3,
wherein the first attachment piece has a first inclined portion that is inclined in the first direction toward the first end from the first bent portion, and
the second attachment piece has a second inclined portion that is inclined in the second direction toward the second end from the second bent portion.

5. A connector comprising:
the terminal according to claim 1; and
a housing having a cavity for storing the terminal.
